(19) United States
(12) Patent Application Publication
(10) Pub. No.: US 2007/0012743 A1
(43) Pub. Date: Jan. 18, 2007

(54) Blade protecting device for an adhesive tape dispeser

(76) Inventor: Hsiu-Man Yu Chen, Taichung (TW)

Correspondence Address: TROXELL LAW OFFICE PLLC, SUITE 1404, 5205 LEESBURG PIKE, FALLS CHURCH, VA, 22041, US

(21) Appl. No.: 11/181,742

(22) Filed: Jul. 15, 2005

(51) Int. Cl. B26F 3/02

(52) U.S. Cl. 225/19

(57) ABSTRACT

A blade-protecting device for an adhesive tape dispenser includes a base of an adhesive tape dispenser, a blade base and a protecting device. The protecting device is composed of an elongate main body, and two side plates bending from two ends of the main body in a right angle. The side plates are pivotally connected with the base of the tape dispenser. An elastic recovering member is combined with each side plate, and the protecting device is located just on the blade base, hiding the blade fixed on the blade base. In using, the blade is exposed out by the adhesive tape pulled and pressed down on the main body of the protecting device to cut off the tape. The elastic recovering members automatically push back the main body after the tape is cut off, protecting the blade from damaged or cutting a finger of a user accidentally contacting it.

### BACKGROUND OF THE INVENTION

1. Field of the Invention

This invention relates to an adhesive tape dispenser, particularly to one having a blade-protecting device for preventing the blade from hurting a person accidentally and from damaged in case of the tape dispenser falling down.

2. Description of the Prior Art

Conventional adhesive tape dispensers generally have a blade positioned at the front part of a base for cutting an adhesive tape pulled out from a tape roll mounted on a tape roll supporter at the rear part of the base for a needed length. The blade is usually is zigzag saw teethed, and always a little protruding up from the blade base. So a user may sometimes be cut or wounded by the protruding-up blade in case of carelessness or absent-mindedness. Or in case of the whole tape dispenser should fall down, the blade is aptly to be struck to be damaged.

### SUMMARY OF THE INVENTION

The feature of a blade protecting device for an adhesive tape dispenser in the invention is an elongate main body with two side plates bending in a right angle from the two ends of the main body and located at two ends of a blade base fixed on a base of an adhesive tape dispenser and also pivotally connected with the base of the tape dispenser. Each side plate is combined with an elastic recovering member for pushing back the main body to cover the blade after the blade cuts off the adhesive tape pulled tightly and pressing on the main body, which is then rotated a little to move down to let the blade so far hidden by the main body to expose out.

### BRIEF DESCRIPTION OF DRAWINGS

This invention will be better understood by referring to the accompanying drawings, wherein:

FIG. 1 is an exploded perspective view of a first preferred embodiment of a blade-protecting device for an adhesive tape dispenser in the present invention;

FIG. 2 is a perspective view of the first preferred embodiment of the blade-protecting device covered on a blade in the present invention;

FIG. 3 is a side view of the first preferred embodiment of the blade-protecting device being opened in the present invention;

FIG. 4 is a perspective view of a second preferred embodiment of a blade protecting device covering on the blade of an adhesive tape dispenser in the present invention; and,

FIG. 5 is a side cross-sectional view of the second preferred embodiment of a blade-protecting device for an adhesive tape dispenser in the present invention.

### DETAILED DESCRIPTION OF THE PREFERRED EMBODIMENTS

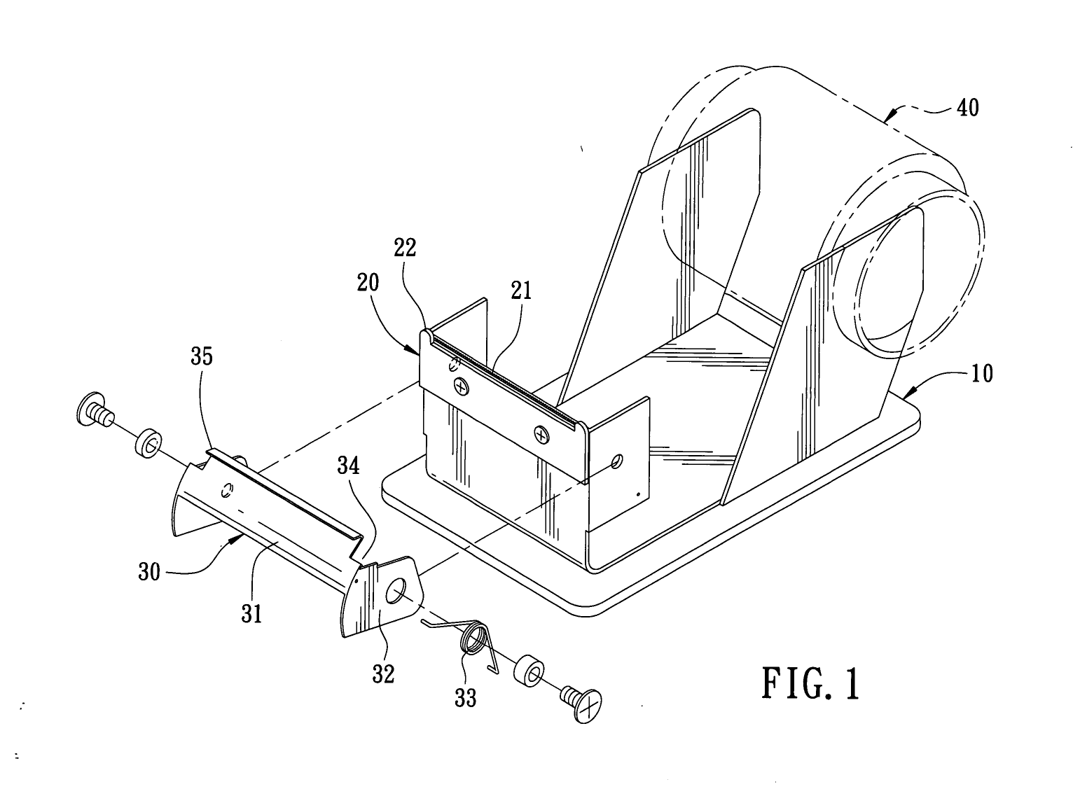

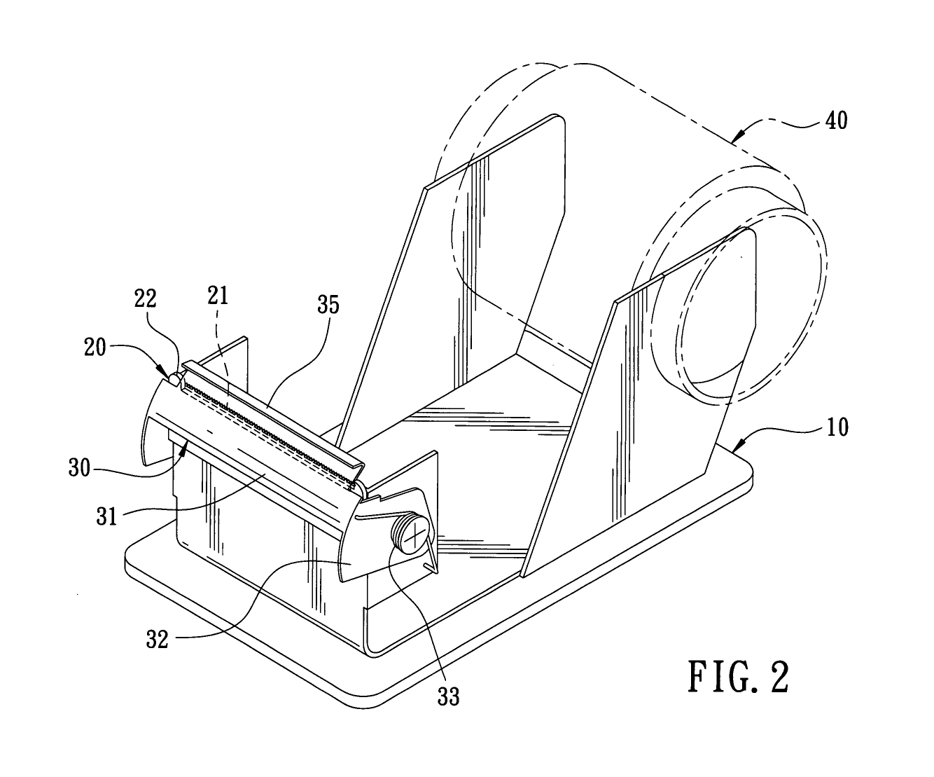

A first preferred embodiment of a blade-protecting device for an adhesive tape dispenser in the present invention, as shown in FIGS. 1 and 2, includes a base 10 of an adhesive tape dispenser, a blade base 20 and a protecting device 30. An adhesive tape roll 40 is supported on a rear portion of the base 10, and the adhesive tape 40 is pulled out rotatingly from the adhesive tape roll 40 for a needed length and then to be cut off by a saw-teethed blade 21 fixed on the blade base 20.

The protective device 30 is composed of a rectangular elongate main body 31, which has a curved cross-section, and a side plate 32 respectively bending inward in a right angle from two ends of the main body 31. Each side plate 32 is also pivotally connected with the base 10 of the adhesive tape dispenser with bolts, and an elastic recovering member 33 is fixed on each side plate 32 by the bolt. The elastic recovering member 33 is a torque spring, and the main body 31 has a notch 34 respectively formed at two ends where the side plates 32 bend from the main body 31, and the blade base 20 is provided with a restrict member 22 respectively at two ends facing the two notches 34 of the main body 31. Further, the main body 31 has an elongate pressing member 35 formed in an upper portion and bending outward for an acute angle for an adhesive tape 40 to press and subsequently rotate the main body 31 a little downward so as to let the blade 21 expose out.

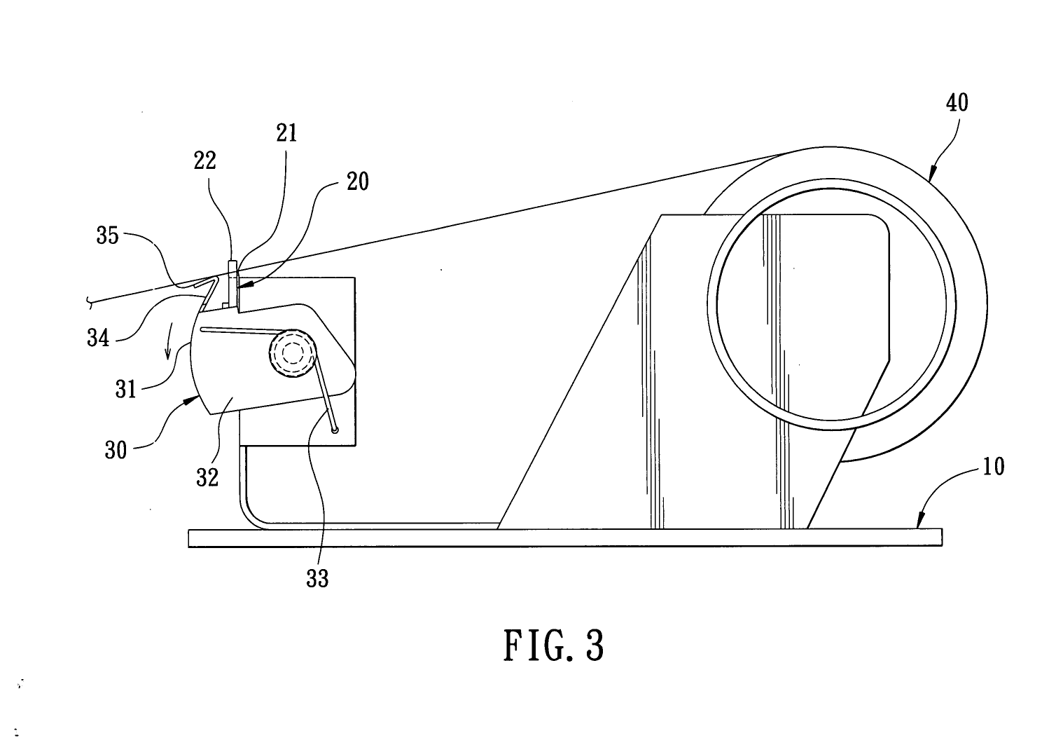

Next, referring to FIGS. 2 and 3, after the blade protecting device is assembled with an adhesive tape dispenser, the protecting device 30 is located just on the upper edge of the blade base 20 with a tiny gap, with the saw-teethed blade 21 protected by the protecting device 30 from contacting with the outer region so that a user cannot touch and be cut by the blade 21 even if the user is careless or absent-minded. In addition, the blade 21 may not be damaged even if the whole tape dispenser should fall down.

In using, the adhesive tape 40 is pulled out for a needed length along on the main body 31, pressing down the pressing member 35, which receives the pressure of the adhesive tape 40 to force the protecting device 30 rotate downward to let pressing member 35 move below the blade 21 so the blade can expose out and cut off the adhesive tape 40. After the adhesive tape 40 is cut off and released manually, the elastic recovering members 33 pushes back the pressing members 35 with the main body 31 rotated back to the original position for hiding the blade base 20 again, with the restrict members 22 of the blade base 20 blocking the notches 34 of the main body 31, and with the protecting device 30 stopped at its normal location.

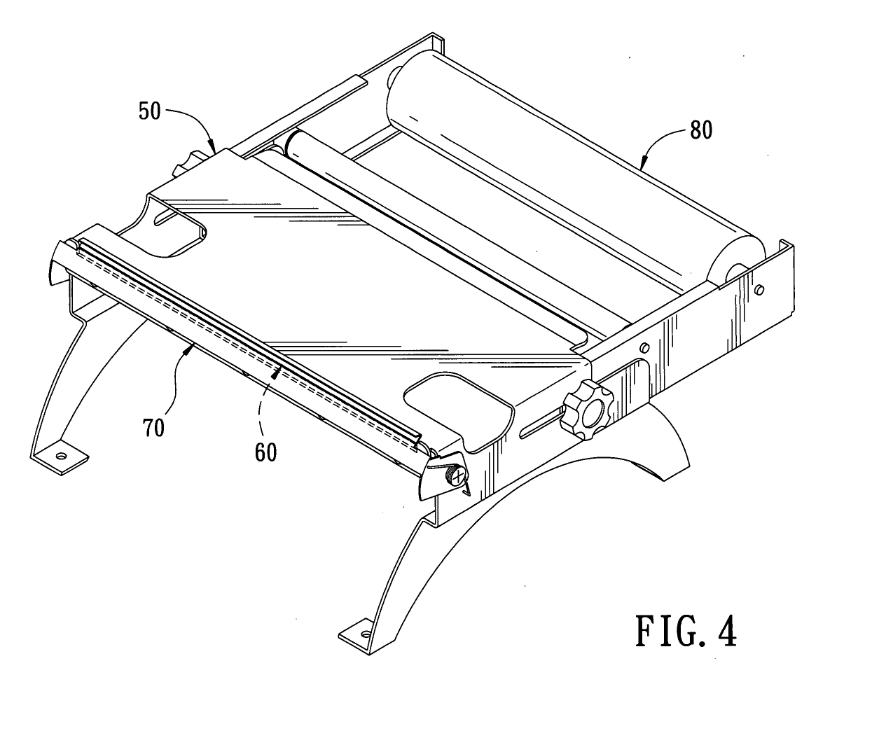

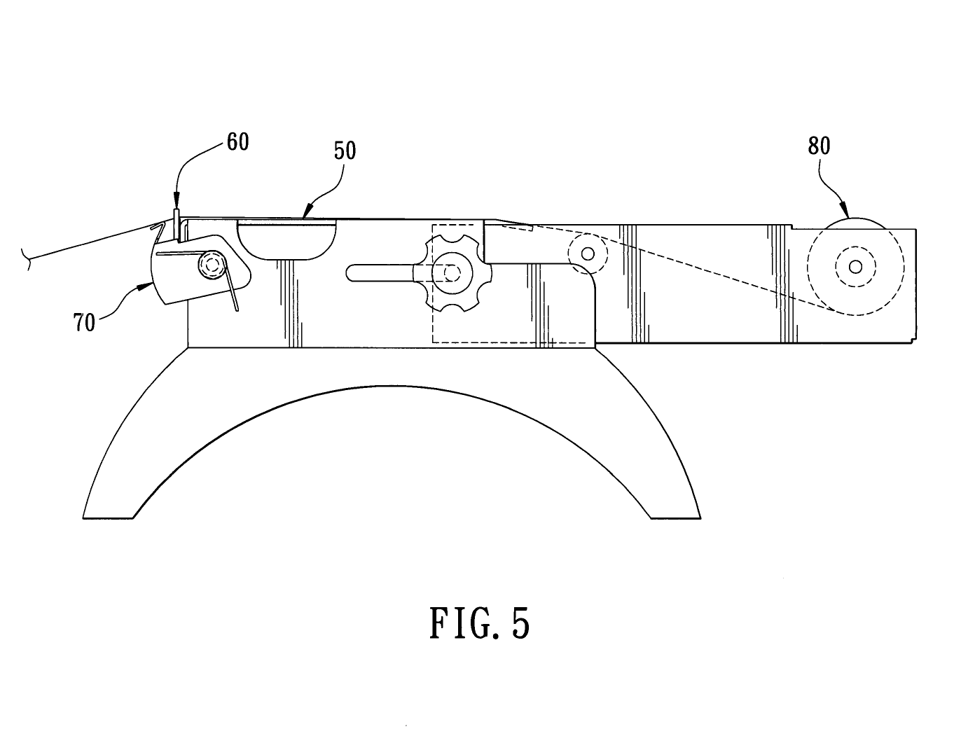

Moreover, FIGS. 4 and 5 show a second preferred embodiment of a blade-protecting device for a different base of another adhesive tape dispenser. The second preferred embodiment includes a base 50 of an adhesive tape dispenser, a blade base 60 and a protecting device 70.

The base 60 is flat, and the blade base 70 is fixed on an front end surface of the base 50, and then the protecting device 70 of the same structure as that 30 of the first preferred embodiment is combined with the blade base 60 so that the protective device in the second preferred embodiment have the same function of that of the first embodiment, protecting an adhesive tape 80 pulled out of a tape roll positioned at the rear portion of the base 50.

The invention has the following advantages, as can be seen from the foresaid description.
1. The blade-protecting device has a function of protecting a user from contacting the blade carelessly and being cut, and also protecting the blade from damaged in case of the whole tape dispenser falls down.
2. The elastic recovering members can push back automatically the protecting device to its original position after an adhesive tape is used and cut by the blade, quite convenient to handle.

While the preferred embodiment of the invention has been described above, it will be recognized and understood that various modifications may be made therein the appended claims are intended to over all such modifications that may fall within the spirit and scope of the invention.

What is claimed is:

1. A blade protecting device for an adhesive tape dispenser comprising a base of an adhesive tape dispenser, a blade base provided with a saw-teethed blade protruding up a little from an upper end of said blade base, and a protecting device to be located on and hiding said blade with a bit gap:
Said protecting device composed of a main body and a side plate respectively bending inward in a right angle from two ends of said main body, said side plates fixed respectively with two sides of said blade base in a pivotal way with said base of said adhesive tape dispenser, an elastic recovering member combined with each said side plate;
Said protecting device rotated a little downward in case an adhesive tape is pulled out on and presses said main body of said protecting device, said blade exposing out to cut said adhesive tape after said main body is rotated downward, said elastic recovering members elastically pushing back said protecting device to its original location after said adhesive tape is cut off by said blade to protect said blade.

2. The blade protecting device for an adhesive tape dispenser as claimed in claim 1, wherein said elastic recovering member is a torque spring.

3. The blade protecting device for an adhesive tape dispenser as claimed in claim 1, wherein said main body of said protecting device has an elongate pressing member formed in an upper elongate portion and bending in an acute angle downward to the front, and said pressing member may be pressed down by an adhesive tape when said adhesive tape is pulled downward and tightly on said pressing member,

4. The blade protecting device for an adhesive tape dispenser as claimed in claim 1, wherein said blade base is provided with a restrict member respectively at two ends, said main body of said protecting device is provided with a notch at two ends facing to said two restrict members of said blade base, and said restrict members block said two notches of said main body in case said elastic recovering members pushes back said main body of said protecting device.
